(19) United States
(12) Patent Application Publication
(10) Pub. No.: US 2023/0313593 A1
(43) Pub. Date: Oct. 5, 2023

(54) CHARGE CONTROL SYSTEM

(71) Applicant: HONDA MOTOR CO., LTD., Tokyo (JP)

(72) Inventor: Akira SAITA, Tokyo (JP)

(73) Assignee: HONDA MOTOR CO., LTD., Tokyo (JP)

(21) Appl. No.: 18/127,405

(22) Filed: Mar. 28, 2023

(30) Foreign Application Priority Data
Mar. 29, 2022 (JP) 2022-054061

(51) Int. Cl. E05F 15/73; B60L 53/62; B60L 53/16; B60L 58/12

(52) U.S. Cl. CPC E05F 15/73; B60L 53/16; B60L 53/62; B60L 58/12; B60L 2240/62; B60L 2250/12; E05Y 2400/45; E05Y 2400/85; E05Y 2900/534

(57) ABSTRACT

A charge control system for a battery mounted on a vehicle configured to perform charge in a state where a charge lid is opened, the charge control system including: a vehicle stop determination unit configured to determine that the vehicle is stopped at a charge site: a charge necessity determination unit configured to determine necessity of charging the battery; a charge lid automatically opening unit configured to perform an automatic opening operation of automatically opening the charge lid; and an automatic opening operation control unit configured to control the automatic opening operation of the charge lid automatically opening unit based on an intention of a user.

### CROSS-REFERENCE TO RELATED APPLICATIONS

This application is based on and claims priority under 35 USC 119 from Japanese Patent Application No. 2022-054061 filed on Mar. 29, 2022, the entire content of which is incorporated herein by reference.

### TECHNICAL FIELD

The present invention relates to a charge control system mounted on a vehicle.

### BACKGROUND ART

In recent years, research and development on electric vehicles that contribute to improvement in energy efficiency have been carried out to secure access to affordable, reliable, sustainable, and modem energy for more people.

Incidentally, in charging an electric vehicle, usually, a user manually opens a charge lid by operating a lever or a button from inside the vehicle, but there is also a demand for automatically opening the charge lid during charge. On the contrary, for example, JP2019-146402A discloses an electric vehicle in which a charge lid is automatically opened when the vehicle is parked near a charger and a remaining battery capacity is equal to or smaller than a constant value.

However, since the charge lid is automatically opened if the remaining battery capacity is equal to or smaller than the constant value, the charge lid is opened even if a user does not intend to charge the battery, and discomfort may be given to the user.

An aspect of the present disclosure relates to provide a charge control system that can automatically open a charge lid without giving discomfort to a user. The present invention contributes to the improvement in the energy efficiency.

### SUMMARY OF INVENTION

According to an aspect of the present disclosure, there is provided a charge control system for a battery mounted on a vehicle configured to perform charge in a state where a charge lid is opened, the charge control system including: a vehicle stop determination unit configured to determine that the vehicle is stopped at a charge site; a charge necessity determination unit configured to determine necessity of charging the battery; a charge lid automatically opening unit configured to perform an automatic opening operation of automatically opening the charge lid; and an automatic opening operation control unit configured to control the automatic opening operation of the charge lid automatically opening unit based on an intention of a user.

### BRIEF DESCRIPTION OF DRAWINGS

FIG. 1 is a diagram showing a schematic configuration of a charge control system 1;

FIG. 2 is a block diagram of a navigation device 29 of the charge control system 1;

FIG. 3 is a block diagram of a charge control device 28 of the charge control system 1;

FIG. 4 is a flowchart of an example of a process performed by the charge control device 28 in FIG. 3;

FIG. 5 is a flowchart of another example of the process performed by the charge control device 28 in FIG. 3;

FIG. 6 is a block diagram showing another configuration example of the charge control device 28 in FIG. 3;

FIG. 7 is a flowchart of an example of threshold setting performed by the charge control device 28 in FIG. 6;

FIG. 8 is a diagram showing a relationship between a remaining capacity of a battery and a threshold in the threshold setting process of FIG. 7; and

FIG. 9 is a diagram showing a setting example of a lower limit remaining capacity in the threshold setting process of FIG. 7.

### DESCRIPTION OF EMBODIMENTS

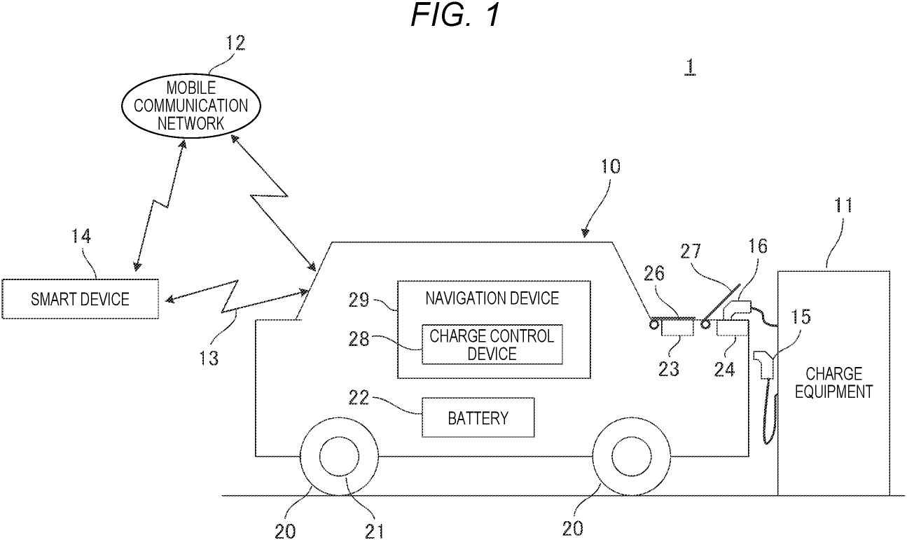

Hereinafter, an embodiment of the present invention will be described with reference to FIGS. 1 to 8.

FIG. 1 shows a configuration example of a charge control system. The charge control system 1 is implemented with an electric vehicle 10, charge equipment 11, and a smart device 14 such as a smartphone communicable with the electric vehicle 10 via a mobile communication network 12 or a short-range wireless communication 13 such as Bluetooth (registered trademark). The smart device 14 is carried by a user such as a driver of the electric vehicle 10, and can perform communication via the mobile communication network 12 or the short-range wireless communication 13 regardless of whether the smart device 14 is inside or outside the electric vehicle 10.

The electric vehicle 10 includes an electric motor 21 that rotationally drives wheels 20, and a battery 22 that supplies power to the electric motor 21. The battery 22 is charged by the charge equipment 11 connected to a system power supply (not shown). The charge equipment 11 is installed in, for example, home of the user of the electric vehicle 10, a business office, or a charge station along a public road.

As a power supply method for the charge equipment 11, there are AC power supply and DC power supply. In the AC power supply, alternating-current power is supplied from the charge equipment 11 to the electric vehicle. The alternating-current power is converted into direct-current power via an AC/DC converter mounted on the electric vehicle, and the battery 11 of the electric vehicle 10 is charged with the direct-current power. In the DC power supply, the AC/DC converter is mounted on the charge equipment 11, and power converted into a direct current in advance is supplied from the charge equipment 11 to the electric vehicle. Generally, the DC power supply can charge the battery more rapidly than the AC power supply. The AC power supply and the DC power supply are wired power supplies. In the AC power supply, an AC power supply plug 15 provided in the charge equipment 11 is attached to a charge port (connector) of the electric vehicle, and in the DC power supply, a DC power supply plug 16 provided in the charge equipment 11 is attached to a charge port (connector) of the electric vehicle.

The electric vehicle 10 includes an AC charge port 23 for the AC power supply and a DC charge port 24 for the DC power supply. For example, the AC charge port 23 and the DC charge port 24 are provided in an upper portion of a front grill of the electric vehicle 10. The AC charge port 23 is covered by a lid 26, and the DC charge port 24 is covered by a lid 27. During charge, between the lids 26 and 27, a lid corresponding to the power supply method of the charge equipment 11 is opened. The electric vehicle 10 may include at least one of the AC charge port 23 and the DC charge port 24. Further, in addition to or instead of the AC charge port 23 and the DC charge port 24, a wireless charge power-reception coil may be provided.

The electric vehicle 10 includes a charge control device 28 that controls charge of the battery 22, and further includes a navigation device 29. The navigation device 29 is also used as an in-vehicle human machine interface (HMI) that mediates exchange of information between the user (or the smart device 14 operated by the user) and the electric vehicle 10 (the charge control device 28). The in-vehicle HMI is not limited to the navigation device 29, and a display audio device or the like may be used.

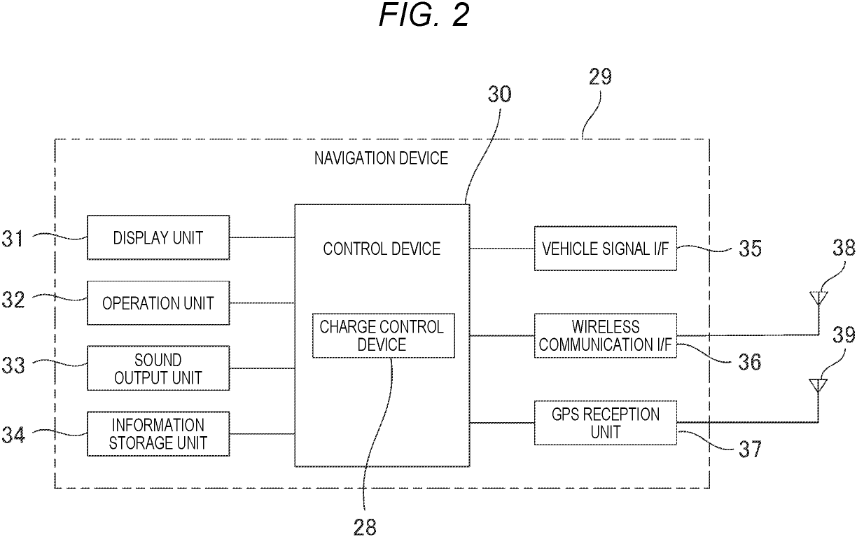

FIG. 2 shows a configuration example of the navigation device 29. The navigation device 29 includes a control device 30, a display unit (display) 31, an operation unit 32, a sound output unit (speaker) 33, an information storage unit 34, a vehicle signal I/F 35, a wireless communication I/F 36, and a GPS reception unit (satellite positioning device) 37.

The display unit 31 displays a map, a current location, and a recommended route from the current location to a destination. The operation unit 32 is operated by the user when the user issues various instructions to the navigation device 29. The display unit 31 and the operation unit 32 may be integrated into one by a touch panel type display. The sound output unit 33 outputs a sound related to route guidance, various information notifications, and the like. The information storage unit 34 stores data such as map data. The vehicle signal I/F 35 mediates signal transmission and reception between a sensor (not shown) such as a vehicle speed sensor and the control device 30. The wireless communication I/F 36 mediates signal transmission and reception between a communication antenna 38 and the control device 30. The navigation device 29 transmits and receives radio waves by the communication antenna 38, and communicates with the smart device 14 via the mobile communication network 12 or the short-range wireless communication 13. The GPS reception unit 37 captures GPS radio waves from a positioning satellite by a GPS antenna 39, and positions a current location based on the GPS radio waves.

The control device 30 is implemented with a processor that can execute a program. The charge control device 28 is implemented with various functional units implemented by the processor of the control device 30 executing the program. The charge control device 28 and the control device 30 may be implemented with separate processors.

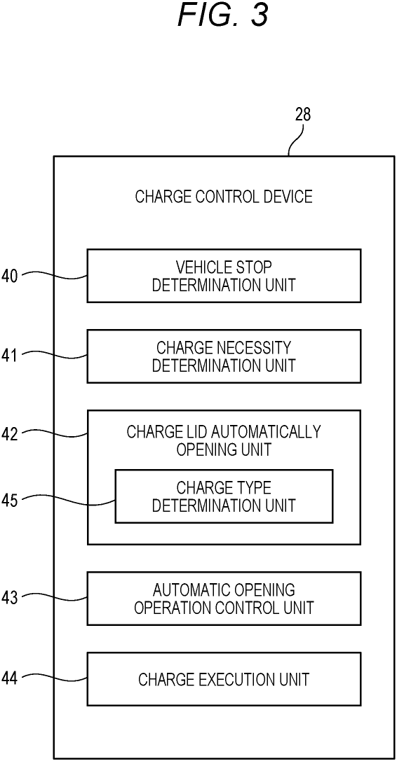

FIG. 3 shows a configuration example of the charge control device 28. The charge control device 28 includes a vehicle stop determination unit 40, a charge necessity determination unit 41, a charge lid automatically opening unit 42, an automatic opening operation control unit 43, and a charge execution unit 44. The vehicle stop determination unit 40, the charge necessity determination unit 41, the charge lid automatically opening unit 42, the automatic opening operation control unit 43, and the charge execution unit 44 are implemented by the processor executing the program. In the present embodiment, the charge control device 28 is mounted on the electric vehicle 10, but the charge control device 28 may be mounted on the smart device 14, may be mounted on a management server that can transmit and receive information between the electric vehicle 10 and the portable terminal 3 by the wireless communication, or may be distributed and mounted on the electric vehicle 10, the management server, and the smart device 14.

The vehicle stop determination unit 40 determines that the electric vehicle 10 has stopped at a charge site. Whether the electric vehicle 10 has stopped can be determined based on an output signal of the vehicle speed sensor. Whether a site where the vehicle is stopped is the charge site can be determined based on a current location acquired by positioning based on the GPS radio waves and site information on map data corresponding to the current location. In the map data, a place where the charge equipment 11 is installed, and a power supply method (the AC power supply or the DC power supply) of the charge equipment 11 installed in the place are registered in advance.

The charge necessity determination unit 41 determines necessity of charging the battery 22. The charge necessity determination unit 41 acquires, for example, a remaining capacity (SOC: state of charge) of the battery 22, and determines that the battery 22 needs to be charged when the SOC is equal to or smaller than a predetermined threshold. Further, the charge necessity determination unit 41 may determine that it is necessary to charge the battery 22 on a specific day or time (for example, every Friday, a day before a travel plan, every day after 19:00, or the like) based on input of the user or based on behavior history of the user. In the following description, a case where the charge necessity determination unit 41 determines that it is necessary to charge the battery 22 when the SOC is equal to or smaller than the predetermined threshold will be described as an example.

The charge lid automatically opening unit 42 performs an automatic opening operation of automatically opening the lid 26 that covers the AC charge port 23 and the lid 27 that covers the DC charge port 24. For example, a motor that opens and closes the lid is provided for each of the lid 26 and the lid 27. The charge lid automatically opening unit 42 automatically opens the lid 26 or the lid 27 by driving the motor.

The charge lid automatically opening unit 42 includes a charge type determination unit 45. The charge type determination unit 45 determines a type of the charge equipment 11 installed at a charge site, that is, the power supply method (the AC power supply or the DC power supply) based on site information on the map data. The charge lid automatically opening unit 42 automatically opens alid corresponding to a type of the charge equipment 11 determined by the charge type determination unit 45 between the lid 26 and the lid 27.

The automatic opening operation control unit 43 controls the automatic opening operation of the charge lid automatically opening unit 42 based on an intention of the user. Enabling or disabling the automatic opening operation performed by the charge lid automatically opening unit 42 can be selected by the user. The selection of enabling or disabling the automatic opening operation is performed on, for example, an operation unit 32 of the smart device 14 or the navigation device 29. When the automatic opening operation is set to be enabled in advance and when the automatic opening operation is accepted in response to a notification, the automatic opening operation control unit 43 automatically opens the lid 26 or the lid 27 through the charge lid automatically opening unit 42. On the contrary, when the automatic opening operation is set to be disabled in advance and when the automatic opening operation is rejected in response to the notification, the automatic opening operation control unit 43 prohibits the automatic opening of the lids 26 and 27.

When enabling/disabling the automatic opening operation is not set in advance, the electric vehicle 10 is stopped at the charge site, and the SOC of the battery 22 is decreased to a value equal to or smaller than the predetermined threshold, the automatic opening operation control unit 43 issues notification inquiring the necessity of the automatic opening operation of the user. The notification is performed through the display unit 31 or the sound output unit 33 of the smart device 14 and/or the navigation device 29. The user who receives the notification accepts or rejects the automatic opening operation on the operation unit 32 of the smart device 14 or the navigation device 29. When the user accepts the automatic opening operation, the automatic opening operation control unit 43 enables the automatic opening operation, and automatically opens the lid 26 or the lid 27 through the charge lid automatically opening unit 42. On the contrary, when the user rejects the automatic opening operation, the automatic opening operation control unit 43 disables the automatic opening operation, and prohibits the automatic opening of the lid 26 or 27.

When enabling/disabling the automatic opening operation is not set in advance, the automatic opening operation control unit 43 may omit to issue the notification inquiring the necessity of the automatic opening operation of the user in the following cases. For example, if the charge site where the electric vehicle 10 is stopped is a predetermined charge site registered in the navigation device 29 in advance, the automatic opening operation control unit 43 can omit the notification of the necessity of the automatic opening operation. Since the notification to the user and the response from the user to the notification are omitted at the predetermined charge site, convenience of the system is improved. Further, when the charge equipment 11 that can perform DC power supply (hereinafter, also referred to as rapid charge equipment) is installed at the charge site where the electric vehicle 10 is stopped, the automatic opening operation control unit 43 can omit to inquire about the necessity of the automatic opening operation. Since the vehicle stop at the place where the rapid charge equipment is installed can infer an intention of the user who performs charge, the notification to the user and the response from the user to the notification are omitted, so that the convenience of the system is improved.

After the opening operation of the lid 26 or 27 by the charge lid automatically opening unit 42 is completed, the charge execution unit 44 charges the battery 22 to a predetermined target SOC through the AC charge port 23 or the DC charge port 24.

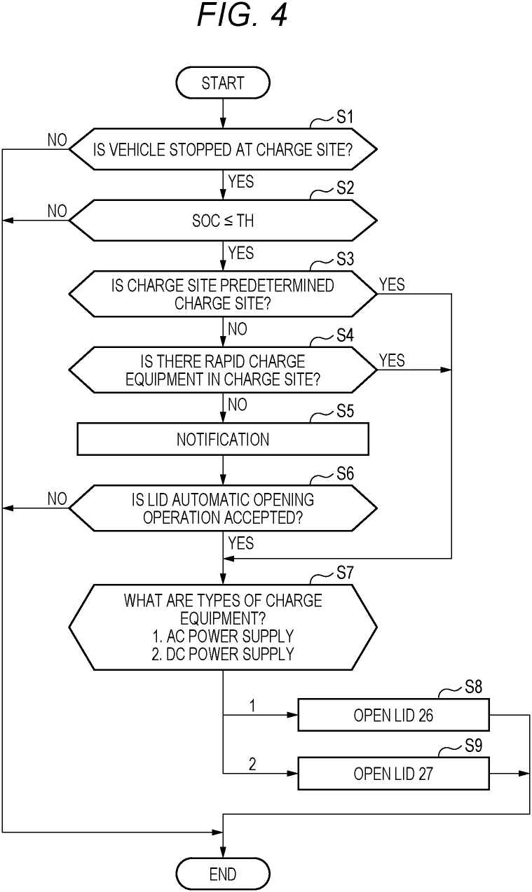

FIG. 4 shows an example of a process performed by the charge control device 28. The charge control device 28 determines that the electric vehicle 10 is stopped at a charge site (step S1). When the electric vehicle 10 is not stopped at the charge site (step S1-No), the process is ended. When the electric vehicle 10 is stopped at the charge site (step S1-Yes), the charge control device 28 acquires the SOC of the battery 22, and determines whether the SOC is equal to or smaller than a predetermined threshold TH (step S2).

When the SOC is not equal to or smaller than the predetermined threshold TH (step S2-No), the process is ended. On the other hand, when the SOC is equal to or smaller than the predetermined threshold TH (step S2-Yes), the charge control device 28 determines that the charge of the battery 22 is necessary. The charge control device 28, which determines that the charge of the battery 22 is necessary, subsequently determines whether the charge site where the electric vehicle 10 is stopped is the predetermined charge site registered in advance in the navigation device 29 (step S3).

When the charge site is not the predetermined charge site (step S3-No), the charge control device 28 subsequently determines whether the charge site where the electric vehicle 10 is stopped is the charge site where the rapid charge equipment is installed (step S4). As a result, when the charge site where the electric vehicle 10 is stopped is not the charge site where the rapid charge equipment is set (step S4-No), the charge control device 28 issues the notification inquiring the necessity of the automatic opening operation of the lid of the user (step S5), and receives a response from the user to the notification (step S6).

When the response from the user who rejects the automatic opening operation is received (step S6-No), the charge control device 28 ends the process without performing the automatic opening operation. On the other hand, when the response from the user who accepts the automatic opening operation is received (step S6-Yes), the charge control device 28 determines the type of the charge equipment 11 installed at the charge site, that is, the power supply method (the AC power supply or the DC power supply) (step S7).

When the charge site is the predetermined charge site (step S3-Yes) or when the charge site where the electric vehicle 10 is stopped is the charge site where the rapid charge equipment is installed (step S4-Yes), the charge control device 28 determines the type of the charge equipment 11 installed at the charge site, that is, the power supply method (the AC power supply or the DC power supply) without issuing the notification inquiring the necessity of the automatic opening operation of the lid of the user (step S7).

When the type of the charge equipment 11 is the AC power supply (step S7-1), the charge control device 28 opens the lid 26 that covers the AC charge port 23 (step S8). Further, when the type of the charge equipment 11 is the DC power supply (step S7-2), the charge control device 28 opens the lid 27 that covers the DC charge port 24 (step S9).

According to the above-described process, first, the charge control device 28 executes the automatic opening operation of the lid based on the intention of the user who enables the automatic opening operation of the lid. Accordingly, automatic opening of the lid which is not desired by the user can be avoided, and a chance that the user feels discomfort can be reduced.

When executing the automatic opening operation of the lid, the charge control device 28 issues the notification inquiring the necessity of the automatic opening operation of the lid of the user. When the user accepts the automatic opening operation of the lid, the charge control device 28 executes the automatic opening operation of the lid. Accordingly, the automatic opening of the lid, which is not desired by the user, can be more reliably avoided.

When the charge site where the electric vehicle 10 is stopped is the predetermined charge site registered in the navigation device 29, and when the rapid charge equipment is installed, the charge control device 28 executes the automatic opening operation of the lid without issuing the notification inquiring the necessity of the automatic opening operation of the lid of the user. In such a case, the notification to the user and the response from the user to the notification are omitted, so that the convenience of the system can be improved.

A specific charge site registered as the predetermined charge site in the navigation device 29 by the user may be home of the user, a charge station frequently used by the user, or the like. Further, registering the specific charge site such as the home of the user or the charge station frequently used by the user in the navigation device 29 is not limited to registration by the user. For example, based on execution history of charge, a charge site where execution frequency of charge is relatively high may be automatically registered as the predetermined charge site by the charge control device 28.

The charge control device 28 determines the type of the charge equipment 11, and opens a lid of a charge port corresponding to the type of the charge equipment 11 from a plurality of lids 26 and 27. Accordingly, the convenience of the system can be improved.

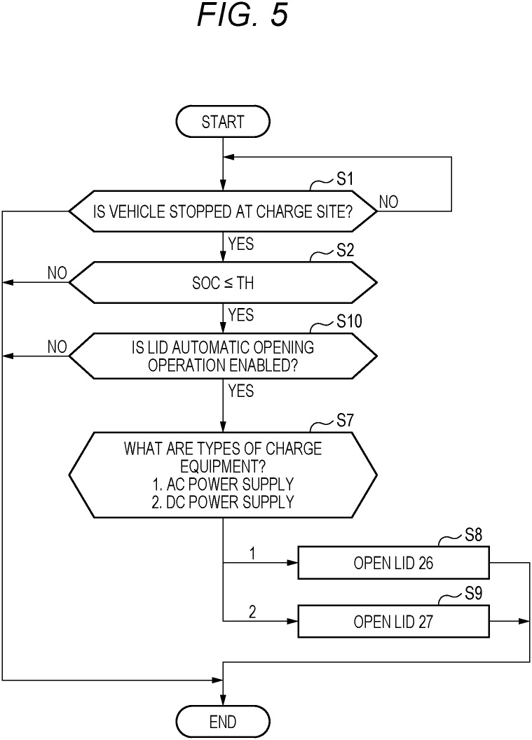

FIG. 5 is a flowchart of another example of the process performed by the charge control device 28. As a modification of the above-described process, the example is an example in which when the user sets the automatic opening operation of the lid to be enabled in advance, the notification to the user and the response from the user to the notification are omitted regardless of whether the charge site is the predetermined charge site, and the charge control device 28 executes the automatic opening operation of the lid.

Specifically, when the electric vehicle 10 is stopped at the charge site (step S1-Yes), and when the SOC is equal to or smaller than the predetermined threshold TH (step S2-Yes), the charge control device 28 determines whether the automatic opening operation of the lid is enabled in advance (step S10). As a result, if the automatic opening operation is not enabled (step S10-No), the charge control device 28 ends the process without performing the automatic opening operation. If the automatic opening operation is enabled (step S10-Yes), the charge control device 28 shifts to step S7 to execute the automatic opening operation of the lid. According to the configuration, the user sets the automatic opening operation to be enabled/disabled in advance, so that the response to the notification can be omitted, and the convenience of the system can be improved.

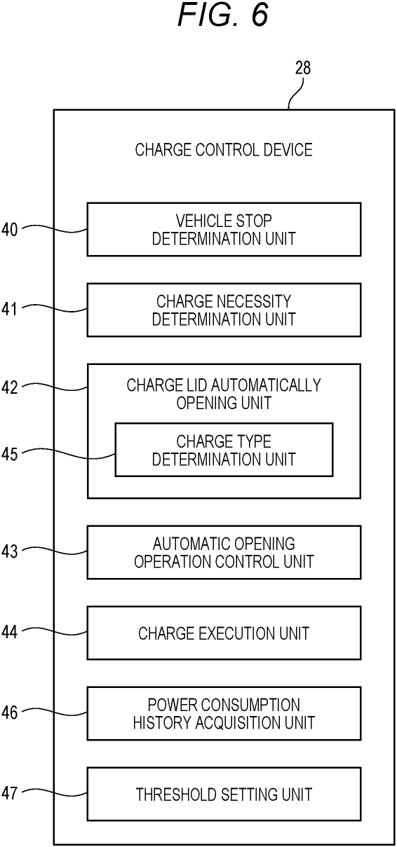

In the processes shown in FIGS. 4 and 5, the threshold TH for the SOC of the battery 22 is fixed in the necessity determination of charging the battery 22 performed by the charge control device 28, but in an example illustrated in FIGS. 6 to 9, the threshold TH is changed based on power consumption history of the battery 22.

FIG. 6 shows a configuration example of the charge control device 28 according to the modification. The charge control device 28 includes a power consumption history acquisition unit 46 that acquires power consumption history of the battery 22, and a threshold setting unit 47 that sets the threshold TH based on the power consumption history in addition to the vehicle stop determination unit 40, the charge necessity determination unit 41, the charge lid automatically opening unit 42, the automatic opening operation control unit 43, and the charge execution unit 44 described above.

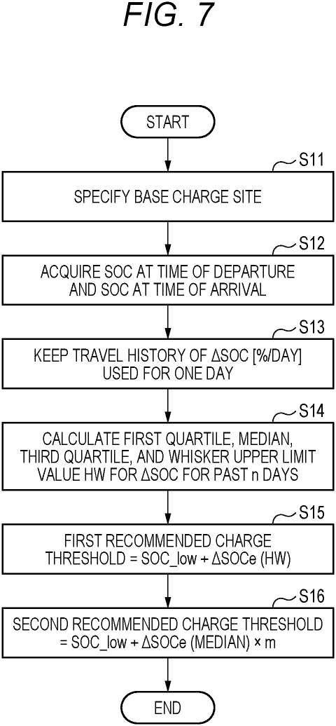

FIG. 7 shows a setting process of the threshold TH performed by the charge control device 28. In step S11, a base charge site of the electric vehicle 10 is specified. Here, through the operation unit 32 of the smart device 14 or the navigation device 29, home of the user having the charge equipment 11 is specified, and is stored in the storage unit of the charge control device 28 (the information storage unit 34 of the navigation device 29).

In step S12, the SOC [%] of the battery 22 when the electric vehicle 10 departs from the base charge site is recorded in the information storage unit 34. In step S12, the SOC of the battery 22 when the electric vehicle 10 returns to the base charge site is further stored in the information storage unit 34.

Next, in step S13, a consumption amount of the battery 22 for one day (a usage amount for one day), which is a difference between the SOC at the time of the departure and the SOC at the time of the return, is obtained as ΔSOC (referred to as a one-day consumption amount ΔSOC or a daily consumption amount ΔSOC) [%/day], and is stored in the information storage unit 34.

In the processes from step S12 to step S13, every time the electric vehicle 10 in which the battery remaining capacity SOC decreases due to travel or air-conditioning usage is used, a difference between the SOC of the battery 22 when the usage starts and the SOC when the usage ends may be set as a consumption amount for one time, consumption amounts for a plurality of times may be integrated, and the consumption amount for one day (the usage amount for one day) ΔSOC may be calculated.

The consumption amount for one day (the usage amount for one day) ΔSOC is calculated on the assumption that the electric vehicle 10 is stopped at the base charge site every day. For example, if there is a chance that the charge can be performed once every two days because the charge equipment 11 registered as the base charge site is common charge equipment in an apartment site, consumption amounts for two days may be calculated.

After the return, the battery 22 is charged by the charge equipment 11 at the base charge site to the target SOC set by the user.

The processes of steps S12 and S13 are repeated every time (here, one time/day), travel history for the most recent n (n is an integer of 2 or more and 31 or less) days is stored in the information storage unit 34, and a statistical process is performed on the travel history in step S14. Since the statistical process is performed on the daily consumption amount for n days ΔSOC, an estimated consumption amount ΔSOCe for one day of the electric vehicle 10 according to user’s tendency in way of use (a daily travel distance, the number of times of charge, a charge amount for one time, and the like) of the electric vehicle 10 is calculated.

In the statistical process of step S14, a maximum value (here, “whisker upper limit value HW” in a whisker plot) excluding a first quartile, a median, a third quartile, and an outlier is obtained for the daily consumption amount for past n days ΔSOC [%/day]. A quartile range is a range from the third quartile to the first quartile.

The whisker upper limit value HW is obtained by the following Equation (1), as is well known.

$$\begin{matrix}\text{HW = third quartile + 1} \text{.5} \times \text{maximum value of data} \\ \text{in quartile range}\end{matrix} \qquad \text{(1)}$$

Next, based on the above-described statistical values, thresholds used for necessity determination of charging the battery 22 are obtained as the first recommended charge threshold (also referred to as a first threshold) shown in the following Equation (2) in step S15 and a second recommended charge threshold (also referred to as a second threshold) shown in the following Equation (3) in step S16.

$$\begin{matrix}\text{First recommended charge threshold = lower limit remaining} \\ \text{capacity +} \left\{\text{estimated consumption amount} \left(\text{median}\right) \text{+}\right) \\ \left(\text{margin amount}\right\} \\ \begin{matrix}= \text{lower limit remaining capacity + whisker upper limit value} \\ = \text{SOC\_low +} Δ \text{SOCe} \left(\text{HW}\right) \left(2\right)\end{matrix}\end{matrix} \qquad \text{(2)}$$

In Equation (2), the lower limit remaining capacity SOC _low is a remaining capacity SOC (default setting by the charge control device 28) considered to cause the user to feel uneasy due to a decrease in a battery remaining capacity during travel, or a remaining capacity that is preset by the user himself/herself and that makes the user feel uneasy.

In the first recommended charge threshold shown in Equation (2), instead of using the “whisker upper limit value HW”, a “value between the third quartile and the whisker upper limit value HW” or “a predetermined value of a consumption amount calculated backward from a cumulative frequency distribution such that a risk of power shortage is equal to or smaller than a predetermined probability” may be set as a set value.

$$\begin{matrix}\text{second recommended charge threshold} \\ \begin{matrix}\begin{matrix}= \text{lower limit remaining capacity +} \left\{\text{estimated consumption}\right) \\ \left(\text{amount} \left(\text{median}\right) + \text{margin amount}\right\}\end{matrix} \\ \begin{matrix}= \text{lower limit remaining capacity +} \left\{\text{estimated consumption}\right) \\ \text{amount} \left(\text{median}\right) + \text{estimated consumption amount} \left(\text{median}\right) \\ \left(\times \left(\text{m - 1}\right)\right\}\end{matrix} \\ \begin{matrix}= \text{lower limit remaining capacity +} \left\{\text{estimated consumption}\right) \\ \left(\text{amount} \left(\text{median}\right) \times \text{m}\right\}\end{matrix} \\ = \text{SOC\_low +} Δ \text{SOCe} \left(\text{median}\right) \times \text{m} \left(3\right)\end{matrix}\end{matrix} \qquad \text{(3)}$$

In Equation (3), the number of days m, which is a multiplier, can be set to the number of days desired by the user depending on how many days before a day on which the lower limit remaining capacity SOC_low is estimated to be reached the user desires to charge the battery 22. Instead of using the “estimated consumption amount (median)” used in calculation of the second recommended charge threshold shown in Equation (3), an “estimated consumption amount (average value)”, an “estimated consumption amount (mode)”, or an “estimated consumption amount (a maximum value of a probability density function)” may be set as a set value.

For example, if the user desires to charge the battery 22 two days (m = 2) before the day on which the lower limit remaining capacity SOC_low is estimated to be reached, the second recommended charge threshold shown in Equation (3) is set by the following Equation (4). The number of days m depends on a rated capacity of the battery 22 mounted on the electric vehicle 10, and is set to, for example, any one integer from m = 2 to 31.

$$\begin{matrix}\text{second recommended charge threshold} \\ \begin{matrix}= \text{SOC\_low +} \text{} Δ \text{SOCe} \left(\text{median}\right) \times 2 \left(4\right) \\ = \text{SOC\_low +} \text{} Δ \text{SOCe} \left(\text{median}\right) + Δ \text{SOCe} \left(\text{median}\right) \\ \begin{matrix}\text{=lower limit remaining capacity +} Δ \text{SOCe} \left(\text{median}\right) + \\ \text{margin amount}\end{matrix} \\ \begin{matrix}\text{=lower limit remaining capacity +} \left\{\text{estimated consumption amount}\right) \\ \left(\left(\text{median}\right) + \text{margin amount}\right\}\end{matrix}\end{matrix}\end{matrix} \qquad \text{(4)}$$

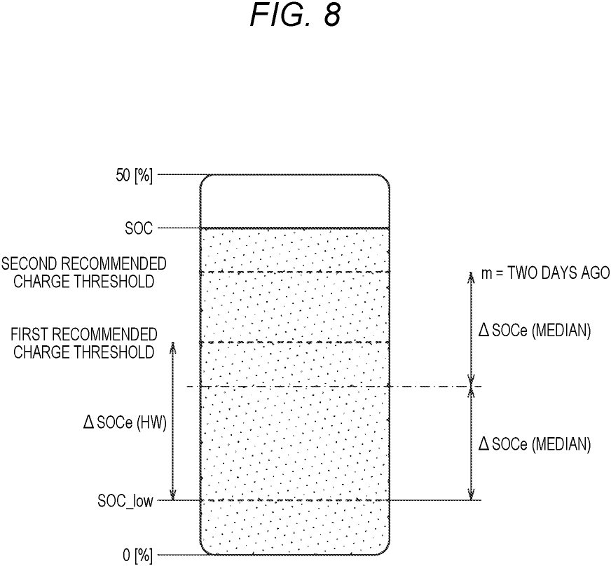

FIG. 8 shows a relationship among the remaining capacity SOC, the first recommended threshold {Equation (2)}, and the second recommended charge threshold {Equation (4)}.

In the statistical process of step S14, with regards to daily SOC [%/day] for past n days, the data may be classified into categories, and the statistical values such as the first quartile, the median, the third quartile, and the “whisker upper limit value HW” in the box-and-whisker plot may be calculated. For example, categories such as a day of the week, and a weekday/holiday are assumed.

In this case, with regards to the ΔSOCe (HW) and the ΔSOCe (median) used for calculating the first recommended charge threshold and the second recommended charge threshold expressed by Equation (2) to Equation (4), an estimated consumption amount ΔSOCe according to a category (the day of the week, or the weekday/holiday) of a corresponding day for estimating a consumption amount is calculated.

FIG. 8 shows 0 to 50 [%] of the battery SOC in an enlarged view as an example of calculation of the first recommended charge threshold and the second recommended charge threshold. As an example, the lower limit remaining capacity SOC_low (the default setting by the charge control device 28), which is considered to make the user feel uneasy, is set to about 10 [%].

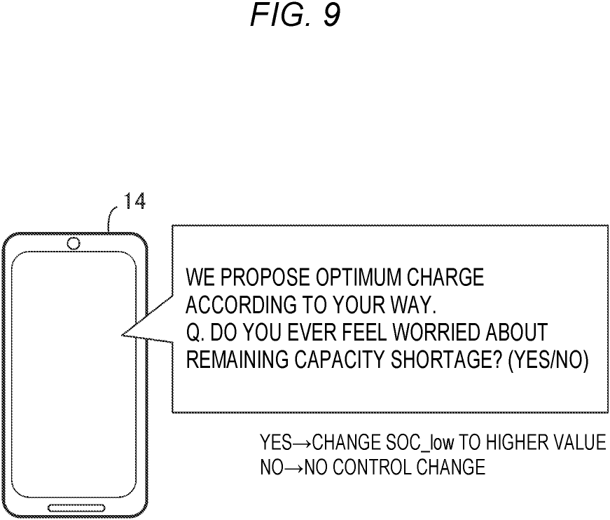

FIG. 9 shows an example of a method for obtaining feedback (power shortage degree uneasy level) of the user from the user of the electric vehicle 10 after using the electric vehicle 10 for a certain period of time for setting the lower limit remaining capacity SOC_low.

That is, after using the electric vehicle 10 for a certain period of time, the charge control device 28 notifies the user through the display unit 31 of the smart device 14 or the navigation device 29. In an example shown in FIG. 9, a question of “we propose optimum charge to battery according to your way. Q: Do you ever feel worried about remaining capacity shortage? (YES/NO)” is asked. When the answer is “Yes” through the operation unit 32 of the smart device 14 or the navigation device 29, the charge control device 28 changes the lower limit remaining capacity SOC _low to a higher value, and when the answer is “NO”, the charge control device 28 does not make the change.

Power shortage uneasiness of the user is eliminated by determining the lower limit remaining capacity SOC_low in advance for the battery 22, the value obtained by adding the estimated consumption amount (the value among values from third quartile to third quartile + whisker upper limit value, or m days times daily consumption amount ΔSOC) to the lower limit remaining capacity SOC_low determined in advance is set as the recommended charge threshold (the first recommended charge threshold or the second recommended charge threshold), these recommended charge thresholds are used as the thresholds TH in the processes shown in FIGS. 4 and 5 to perform the automatic opening operation of the lid at appropriate timing, and charge is recommended, so that it is possible to prevent the battery from being charged unnecessarily earlier even though the battery has a sufficient battery remaining capacity that enables travel on the next day. Accordingly, by increasing use frequency of a low SOC region, standing deterioration in the remaining capacity SOC under high charge (including full charge) is avoided, and the number of times of charge (charge frequency) is suppressed, so that convenience of the user can be improved. The recommended charge threshold is set to, for example, a remaining capacity SOC of about 30 [%] as small as possible within a range in which there is no problem in travel on the next day.

A margin charge amount (first recommended charge threshold) is set as a set value of a value between the third quartile calculated from the consumption amount for n days and the whisker upper limit, so that the margin charge amount can be set to be larger than a median of the daily consumption amount ΔSOC, and the power shortage uneasiness can be further prevented.

The automatic opening operation of the lid is performed in a stepwise manner (m days before a day when the SOC of the battery 22 falls below the second recommended charge threshold, and during return on a current day when the SOC of the battery 22 falls below the first recommended charge threshold) according to the SOC of the battery 22, so that it is possible to remind the user of necessity of charge, and therefore it is possible to appropriately prevent the power shortage uneasiness.

A power shortage uneasiness degree of the user is acquired, and the larger the power shortage uneasiness degree is, the larger the value is set, and therefore it is possible to perform an appropriate automatic opening operation of the lid according to how the user feels about the power shortage.

As another modification, the threshold setting unit 47 may set a threshold based on a power consumption prediction value based on a travel plan for a next day. In this case, the charge control device 28 includes a travel schedule acquisition unit that acquires a travel schedule. The travel schedule acquisition unit acquires the travel schedule of the user in cooperation with schedule information registered in advance in a management server 2. For example, the travel schedule acquisition unit acquires departure/arrival scheduled day and time of a trip, a schedule to go out, and the like registered in the portable terminal 3.

When the schedule information of the user is stored in the portable terminal 3 or another server, the travel schedule acquisition unit may communicate with the portable terminal 3 or the other server via the wireless communication to acquire the schedule information of the user. Further, when the schedule information of the user is stored in the navigation device provided in the vehicle 1, the travel schedule acquisition unit may acquire the schedule information of the user from the navigation device.

In a case of the modification, when charge up to SOC 100% is necessary for going on a long trip the next day although the consumption amount is normally small because of commuting use, the charge necessity determination unit 41 can determine that the charge is necessary even at SOC 60%.

Although various embodiments have been described above with reference to the drawings, it is needless to say that the present invention is not limited to these examples. It will be apparent to those skilled in the art that various changes and modifications may be conceived within the scope of the claims. It is also understood that the various changes and modifications belong to the technical scope of the present invention. Further, the constituent elements in the embodiments described above may be combined freely within a range not departing from the spirit of the invention.

In the present specification, at least the following matters are described. Constituent elements and the like corresponding to those according to the embodiments described above are shown in parentheses. However, the present invention is not limited thereto.

(1) A charge control system (the charge control system 1) for a battery (the battery 22) mounted on a vehicle (the electric vehicle 10) configured to perform charge in a state where a charge lid (the lid 26, 27) is opened, the charge control system including:
a vehicle stop determination unit (the vehicle stop determination unit 40) configured to determine that the vehicle is stopped at a charge site;
a charge necessity determination unit (the charge necessity determination unit 41) configured to determine necessity of charging the battery;
a charge lid automatically opening unit (the charge lid automatically opening unit 42) configured to perform an automatic opening operation of automatically opening the charge lid; and
an automatic opening operation control unit (the automatic opening operation control unit 43) configured to control the automatic opening operation of the charge lid automatically opening unit based on an intention of a user.

According to (1), the automatic opening operation of the lid is controlled based on the intention of the user, so that automatic opening of the lid which is not desired by the user is avoided, and a chance that the user feels discomfort is reduced.

(2) The charge control system according to (1),

in which the automatic opening operation control unit (the automatic opening operation control unit 43) is configured to allow a user to select enabling or disabling the automatic opening operation.

According to (2), it is possible to set enabling/disabling of the automatic opening operation, so that the automatic opening of the lid which is not desired by the user is avoided, and the chance that the user feels the discomfort is reduced.

(3) The charge control system according to (2),
in which the automatic opening operation control unit (the automatic opening operation control unit (43)
issues a notification inquiring necessity of the automatic opening operation of the user when the vehicle is stopped at the charge site and charge of the battery is necessary, and
enables the automatic opening operation and automatically opens the charge lid when a user accepts the automatic opening operation.

According to (3), since the automatic opening operation is executed according to the acceptance of the user for the notification, the automatic opening of the lid which is not desired by the user is avoided.

(4) The charge control system according to (3),
in which the automatic opening operation control unit (the automatic opening operation control unit 43)
enables the automatic opening operation without issuing the notification when the charge site where the vehicle is stopped is a predetermined charge site registered in a navigation device (the navigation device 29).

According to (4), since the notification to the user and a response from the user to the notification are omitted at the predetermined charge site, convenience of the system is improved.

(5) The charge control system according to (3),

in which when rapid charge equipment is installed at the charge site where the vehicle is stopped, the automatic opening operation is enabled without issuing the notification.

According to (5), since the vehicle stop at the place where the rapid charge equipment is installed can infer an intention of the user who performs charge, the notification to the user and the response from the user to the notification are omitted, so that the convenience of the system is improved.

(6) The charge control system according to (2),

in which, in a case where a user sets the automatic opening operation to be enabled in advance, the automatic opening operation control unit automatically opens the charge lid when the vehicle is stopped at the charge site and charge of the battery is necessary.

According to (6), enabling/disabling the automatic opening operation can be set in advance, so that a trouble of the user who accepts charge each time is eliminated, and the convenience of the system is improved.

(7) The charge control system according to any one of (1) to (6), further including:
a charge type determination unit (the charge type determination unit 45) configured to determine a type of charge equipment,
in which the charge lid automatically opening unit opens a charge lid of a charge port corresponding to the type of the charge equipment from a plurality of charge lids of the vehicle.

According to (7), since the charge lid is opened according to the type of the charge equipment, the convenience of the system is improved.

(8) The charge control system according to any one of (1) to (7), further including:
a power consumption history acquisition unit (the power consumption history acquisition unit 46) configured to acquire power consumption history of the battery; and
a threshold setting unit (the threshold setting unit 47) configured to set a threshold for determining the necessity of charging the battery based on the power consumption history.

According to (8), since the threshold for determining the necessity of the charge is set based on the power consumption history, it is possible to perform charge control that reflects consumption tendency of the user.

(9) The charge control system according to any one of (1) to (7), further including:
a travel schedule acquisition unit configured to acquire a travel schedule; and
a threshold setting unit (the threshold setting unit 47) configured to set a threshold for determining the necessity of charging the battery based on a power consumption prediction value based on a travel plan for a next day.

According to (9), since the threshold is set based on the power consumption prediction value based on the travel plan for the next day, it is possible to avoid power shortage even if the vehicle travels for a long distance.

What is claimed is:

1. A charge control system for a battery mounted on a vehicle configured to perform charge in a state where a charge lid is opened, the charge control system comprising:
a vehicle stop determination unit configured to determine that the vehicle is stopped at a charge site:
a charge necessity determination unit configured to determine necessity of charging the battery;
a charge lid automatically opening unit configured to perform an automatic opening operation of automatically opening the charge lid; and
an automatic opening operation control unit configured to control the automatic opening operation of the charge lid automatically opening unit based on an intention of a user.

2. The charge control system according to claim 1, wherein the automatic opening operation control unit is configured to allow a user to select enabling or disabling the automatic opening operation.

3. The charge control system according to claim 2, wherein the automatic opening operation control unit
issues a notification inquiring necessity of the automatic opening operation of the user when the vehicle is stopped at the charge site and charge of the battery is necessary, and
enables the automatic opening operation and automatically opens the charge lid when a user accepts the automatic opening operation.

4. The charge control system according to claim 3, wherein the automatic opening operation control unit enables the automatic opening operation without issuing the notification when the charge site where the vehicle is stopped is a predetermined charge site registered in a navigation device.

5. The charge control system according to claim 3, wherein when rapid charge equipment is installed at the charge site where the vehicle is stopped, the automatic opening operation is enabled without issuing the notification.

6. The charge control system according to claim 2, wherein, in a case where a user sets the automatic opening operation to be enabled in advance, the automatic opening operation control unit automatically opens the charge lid when the vehicle is stopped at the charge site and charge of the battery is necessary.

7. The charge control system according to claim 1, further comprising:
a charge type determination unit configured to determine a type of charge equipment,
wherein the charge lid automatically opening unit opens a charge lid of a charge port corresponding to the type of the charge equipment from a plurality of charge lids of the vehicle.

8. The charge control system according to claim 1, further comprising:
a power consumption history acquisition unit configured to acquire power consumption history of the battery: and
a threshold setting unit configured to set a threshold for determining the necessity of charging the battery based on the power consumption history.

9. The charge control system according to claim 1, further comprising:
a travel schedule acquisition unit configured to acquire a travel schedule; and
a threshold setting unit configured to set a threshold for determining the necessity of charging the battery based on a power consumption prediction value based on a travel plan for a next day.
